(19) United States
(12) Patent Application Publication
(10) Pub. No.: US 2007/0189422 A1
(43) Pub. Date: Aug. 16, 2007

(54) Radio demodulation circuit

(76) Inventors: Jun Ogawa, Kyoto (JP); Yoshishige Yoshikawa, Nara (JP)

Correspondence Address: MCDERMOTT WILL & EMERY LLP, 600 13TH STREET, NW, WASHINGTON, DC, 20005-3096, US

(21) Appl. No.: 11/707,098

(22) Filed: Feb. 16, 2007

(30) Foreign Application Priority Data
Feb. 16, 2006 (JP) 2006-039208
Feb. 6, 2007 (JP) 2007-26435

(51) Int. Cl. H04L 27/14

(52) U.S. Cl. 375/334

(57) ABSTRACT

The radio demodulation circuit of the present invention demodulates a multi-valued FSK signal with a digital demodulator, performs threshold value judgment on the demodulated output of the digital demodulator with a data judging device, and keeps the threshold value obtained by the data judging device in a threshold value holding device.

### BACKGROUND OF THE INVENTION

1. Field of the Invention

The present invention relates to a radio demodulation circuit that performs optimization of a threshold value and correction of data synchronizing point at data judgment in a data communication through multi-valued FSK radio communication using an FSK signal that is a kind of frequency modulation signals.

2. Description of the Related Art

Conventionally, a data communication system is widely used as a method of data communication, wherein radio-transmission of various kinds of data is performed through FSK radio communication by using the FSK (Frequency Shift Keying) signal that is a kind of FM (frequency modulation) signals.

When data is transmitted in data communication through the FSK radio communication, first, the frequency of a digital signal is modulated by having the frequency of a carrier wave shifted in accordance with “1”, “0” of the digital signal. Then, a high-frequency signal obtained thereby is transmitted as a radio wave. The transmitted high-frequency signal is received with an FSK receiver, and the transmitted data is demodulated. At a time of demodulation, a frequency component of a demodulation base band signal that is voltage-converted with a frequency-voltage converting circuit is compared through a comparator to determine a digital value, and the originally transmitted data can be obtained based on the determined data.

For achieving a high-speed transmission in a narrow-band FSK radio communication, multi-valued signals are used from the viewpoint of effective utilization of the frequency. When the signal is made multi-valued, for example, in the case of being made four-valued, the carrier waves are frequency-shifted by corresponding to “00”, “01”, “11”, “10” of the digital signals. In this case, three kinds of comparators are prepared to obtain the originally transmitted data by comparing “00” and “01”, “01” and “11”, and “11” and “10”, respectively.

In a case of achieving the communication in the same band with the four-valued FSK radio communication described above, judgment of the threshold value becomes more critical. In addition, it is necessary to determine the more accurate data sampling point. Thus, for achieving a high-speed transmission, it is required to achieve a more accurate synchronization between the transmitter side and the receiver side.

In the meantime, in a conventional FSK receiving device (for example, a Japanese published patent literature (see Japanese Unexamined Patent Publication H9-8854), FSK demodulation is performed through analog processing, and judgment of the threshold values is performed by an analog converter. In the conventional FSK receiving device, FSK demodulation is performed with analog processing, the optimum threshold value is calculated from a bit synchronizing signal, a bit error rate and the like, and the calculated result is fed back to a reference voltage of a threshold value judging comparator to obtain the optimum threshold value. However, if the threshold value has a width due to the variation in the reference voltage of the comparator, the width between the threshold values becomes narrow. Thus, there is a limit in judgment in multi-valued modulation at receipt of the signals. Further, for determining the synchronizing point, there is also a limit in achieving the synchronization between the transmitter side and the receiver side since synchronization is performed with the original clock based on the transmission speed information. These are large factors for giving a bad influence to the receipt characteristic for achieving the high-speed transmission.

As described above, in the above-described conventional FSK receiving device, a threshold value correction device is constituted with an analog comparator. Thus, there exist a large variation in the operation property of the circuit no matter how precisely the threshold value calculator, which can be constituted with an analog circuit or a digital circuit, is formed. Therefore, a noise is superimposed on the reference voltage of the threshold correction device (analog comparator), so that the judging result is largely deteriorated. Furthermore, when the threshold value calculator is constituted with an analog circuit, it is difficult to determine the accurate data sampling point.

### SUMMARY OF THE INVENTION

The main object of the present invention therefore is to achieve a high-speed transmission through performing judgment of a threshold value with high accuracy and determining a more accurate data sampling point.

In order to achieve the aforementioned object, the radio demodulation circuit of the present invention comprises: a digital demodulator for demodulating a multi-valued FSK signal; a data judging device for judging a demodulated output of the digital demodulator based on a threshold value; and a threshold value holding device for keeping the threshold value obtained by the data judging device. Herewith, more accurate threshold value judgment becomes possible, so that the receipt characteristic can be improved.

There is such an embodiment that the radio demodulation circuit of the present invention further comprises: a synchronizing point detecting device that detects changing points in the demodulated output, and then detects synchronizing points of the multi-valued FSK signal based on the changing points detected; and a demodulation signal synchronizing output device that outputs a threshold value judgment result that is obtained by the data judging device at the synchronizing points, and a synchronizing clock that synchronizes with transmission speed of the demodulated output. In this case, it is preferable to further comprise a synchronizing point holding device for keeping the synchronizing points.

There is also such an embodiment that the radio demodulation circuit of the present invention further comprises a multi-valued synchronizing point judging device, wherein: the multi-valued FSK signal includes a plurality of frequency components whose modulation degrees are set in accordance with each code that is superimposed on the signal; the demodulated output comprises a plurality of voltage components that correspond to the plurality of frequency components; and the multi-valued synchronizing point judging device selectively judges, as synchronizing points, the synchronizing points at which a voltage transition is generated between the voltage components in accordance with the frequency components wherein the modulation degrees are equally deviated from a center frequency of the multi-valued FSK signal in the threshold value judgment result.

Further, there is also such an embodiment that the radio demodulation circuit of the present invention further comprises a multi-valued synchronizing point judging device, wherein: the multi-valued FSK signal comprises a plurality of frequency components whose modulation degrees are set in accordance with each code that is superimposed on the signal; the demodulated output comprises a plurality of voltage components that correspond to the plurality of frequency components; and the multi-valued synchronizing point judging device extracts the synchronizing points from a synchronizing point group that is detected by the synchronizing point detecting device in the threshold value judgment result, at which a voltage transition is generated between the voltage components that correspond to the frequency components wherein the modulation degrees are largest to a center frequency of the multi-valued FSK signal, and judges the extracted synchronizing points as synchronizing points. In this case, there is also such an embodiment that: the threshold value holding device sets, as the threshold values in multi-valued modulation, threshold values that is differentiable into binary apparently; and the multi-valued synchronizing point judging device extracts the synchronizing points at which a pseudo-change to binary is generated from the threshold value judgment result, and judges the extracted synchronizing points as synchronizing points. Herewith, even in the case where the synchronizing points are detected based on transition of a specific voltage, it is possible to detect the synchronizing points that are similar to those obtained in the case of two-value modulation. Therefore, synchronization between the transmitter side and the receiver side can be achieved much faster.

There is also such an embodiment that the radio demodulation circuit of the present invention comprises: a maximum value holding device for keeping a maximum value of the demodulated output; a minimum value holding device for keeping a minimum value of the demodulated output; and an optimum threshold value calculator for calculating an optimum value of the threshold values based on an output of the maximum value holding device and an output of the minimum value holding device, wherein the threshold value holding device keeps the threshold value calculated by the optimum threshold value calculator. Herewith, the optimum threshold value can be calculated from the received data itself, and thereby it enables much better threshold value judgment. Further, as it is possible to set the threshold value for each communication in accordance with the radio wave condition at that time, a stable communication can be achieved as needed.

There is also such an embodiment that the radio demodulation circuit of the present invention further comprises: a synchronizing point monitoring device which: determines a synchronizing point based on a counted number of the synchronizing points held in the synchronizing point holding device; after determining the synchronizing point, extracts synchronizing points that are detected within an arbitrary range on a time axis with a central focus on the determined synchronizing point; and judges the extracted synchronizing points as synchronizing points.

Furthermore, it is possible to constitute a remote controller with: a radio communication LSI to which the radio demodulation circuit according to the present invention is mounted for performing radio transmission and reception; an antenna for transmitting and receiving a radio signal of the radio communication LSI; a microcontroller for performing a control of the radio communication LSI; a key input device through which input to the microcontroller is performed; and a display device for performing an arbitrary display through a control from the microcontroller.

According to the present invention described above, the accurate data sampling point can be determined through detection of the accurate synchronizing point. Thus, it is possible to judge the data accurately even in a high-speed transmission. Further, since the data sampling points are determined by following the synchronizing points at all times, it becomes possible to perform communication while correcting the error of the clock accuracy, which contributes to the speeding up of the radio communication. This enables the accurate threshold value judgment so as to improve the receipt characteristic.

Further, even in the case where the synchronizing points are detected based on transition of a specific voltage, it is possible to detect the synchronizing points that are equal to those obtained in the case of binary modulation. Therefore, synchronization between the transmitter side and the receiver side can be achieved much faster.

Furthermore, the optimum threshold value can be calculated form the received data itself, so that much better optimum threshold value judgment can be achieved. Moreover, since the threshold value is set for each communication in accordance with the radio wave condition at that time, it is possible to achieve stable communication as needed. This enables a stable radio receiving device to be achieved.

Through the structure of the present invention described above, it is possible to obtain the more accurate data judgment and to achieve synchronization between the transmitter side and the receiver side even in the multi-valued FSK radio communication. Thus, a high-speed communication can be achieved and the radio receipt characteristic can be improved.

The radio demodulation circuit of the present invention is capable of achieving high-speed transmission and highly accurate communication in the multi-valued FSK radio communication. Therefore, it is useful in the field of radio devices, which requires the high-speed communication without deteriorating the radio receipt characteristic.

### BRIEF DESCRIPTION OF THE DRAWINGS

Other objects of the present invention will become clear from the following description of the preferred embodiments and the appended claims. Those skilled in the art will appreciate that there are many other advantages of the present invention possible by embodying the present invention.

FIG. 1 is a block diagram showing a schematic structure of an FSK radio device that uses a radio demodulation circuit according to a first embodiment of the present invention;

FIG. 2 is a block diagram showing a schematic structure of an FSK radio device that uses a radio demodulation circuit according to a second embodiment of the present invention;

FIG. 3 is a block diagram showing a schematic structure of an FSK radio device that uses a radio demodulation circuit according to a third embodiment of the present invention;

FIG. 4 is a timing chart of judging a threshold value of a demodulation base band signal according to the second embodiment of the present invention;

FIG. 5 is an illustration showing code transitions and detection change points in four-valued FSK radio communication according to the second embodiment of the present invention;

FIG. 6 is a timing chart of judging the code in the four-valued FSK radio communication according to the second embodiment of the present invention;

FIG. 7 is a block diagram showing a schematic structure of an FSK radio device that uses a radio demodulation circuit according to a fourth embodiment of the present invention;

FIG. 8 is an illustration showing code transitions and synchronizing point monitoring range in the four-valued FSK radio communication according to the fourth embodiment of the present invention; and

FIG. 9 is a block diagram showing a schematic structure of a remote controller according to a fifth embodiment of the present invention.

### DETAILED DESCRIPTION OF THE INVENTION

Hereinafter, a radio demodulation circuit according to embodiments of the present invention will be described concretely referring to the accompanying drawings.

### First Embodiment

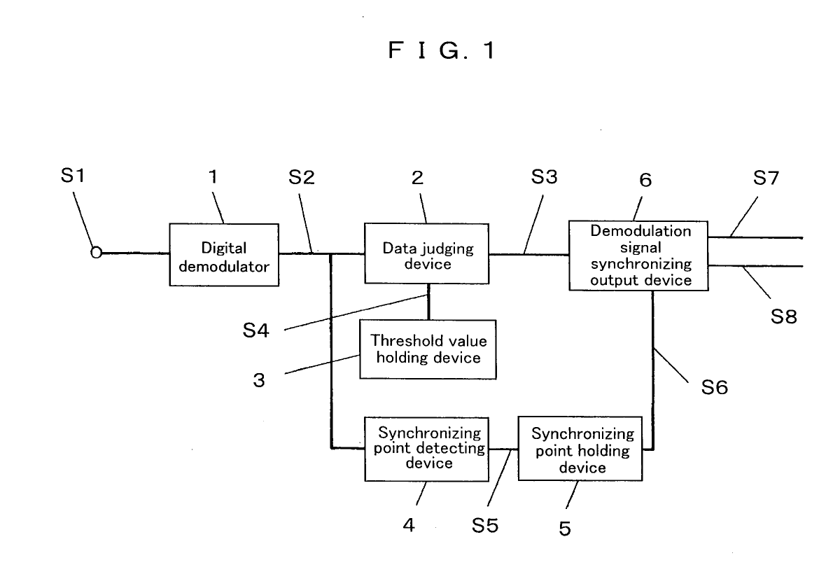

The radio demodulation circuit according to a first embodiment of the present invention will be described. FIG. 1 is a block diagram showing an example of the structure of the radio demodulation circuit of the first embodiment. More specifically, it is a circuit structure for judging the data threshold value and determining the synchronizing point in a multi-valued FSK radio communication.

First, the structure of this embodiment will be described. In FIG. 1, reference numeral 1 is a digital demodulator. A multi-valued FSK signal S1, which is obtained by downconverting, filtering, and digitalizing a high-frequency signal, is inputted to the digital demodulator 1. The digital demodulator 1 performs digital demodulation of FSK by performing frequency-voltage conversion of the inputted multi-valued FSK signal. Reference numeral 2 is a data judging device. The data judging device 2 performs four-valued data judgment from the output signal of a demodulation base band signal S2 that is frequency-voltage converted by the digital demodulator, and outputs a demodulation data signal S3. Reference numeral 3 is a threshold value holding device. The threshold value holding device 3 keeps a judging threshold value of the data judging device 2, and outputs threshold value information S4. Reference numeral 6 is a demodulation signal synchronizing output device. The demodulation signal synchronizing output device 6 generates a clock signal that is synchronized with the transmission speed of the threshold value information 4 and the demodulation data signal S3, and outputs the clock signal and the demodulation data signal S3 as the digital data in a synchronized manner. Hereinafter, the clock signal outputted from the demodulation signal synchronizing output device 6 is referred to as a synchronizing digital clock S7, and the demodulation data signal S3 outputted from the demodulation signal synchronizing output device 6 by being synchronized with the synchronizing digital clock S7 is referred to as synchronizing digital data S8. Reference numeral 4 is a synchronizing point detector. The synchronizing point detector 4 detects the synchronizing point by detecting the voltage change point of the demodulation base band signal. Hereinafter, the information regarding the synchronizing point detected position that is detected by the synchronizing point detector 4 is referred to as synchronizing point detected position information S5. Reference numeral 5 is a synchronizing point holding device. The synchronizing point holding device 5 keeps the synchronizing point detected position information S5, and then holds the more stored synchronizing point as the optimum synchronizing point. Hereinafter, the information regarding the synchronizing point that is outputted from the synchronizing point holding device 5 is referred to as synchronizing point position information S6.

Hereinafter, the detailed operation of the radio demodulation circuit according to the first embodiment will be described. The multi-valued FSK signal S1 is generated through performing the following processing to a high-frequency signal in advance.
Down-converting processing for enabling digital processing even at a slow processing speed
Filtering processing for eliminating signals that are out of a desired frequency band
A/D conversion processing

The multi-valued FSK signal S1 generated in this manner is inputted to the digital demodulator 1. The digital demodulator 1 performs frequency-voltage conversion on the inputted multi-valued FSK signal S1 to generate the demodulation base band signal S2. There are various kinds of methods for the frequency-voltage conversion, and any methods can be employed in this case. The data judging device 2 judges the threshold value of the demodulation base band signal S2, and outputs threshold value information S4.

The threshold value information S4 functions as the threshold value for judging data. The threshold value information S4 is held in the threshold value holding device 3. The threshold value holding device 3 may be any kinds of storage device as long as it is a mechanism capable of holding the values. The threshold value holding device 3 is constituted with a ROM, a RAM, and a register. Further, the threshold value maybe set as a fixed value. In the followings, operation of a radio demodulation circuit that comprises the threshold value holding device 3 constituted with a register will be described as an example of them. There are various kinds of the multi-valued FSK modulation. However, the explanation provided in the followings refers to the case of the four-valued FSK modulation as an example of them.

When the modulation number in FSK modulation increases to eight values, sixteen values, and so on, the number of threshold values fluctuates accordingly. Thus, in this radio demodulation circuit, it is necessary to increase the number of the threshold values to be held in accordance with the fluctuation. In the case of four-valued FSK modulation, the threshold value is set in order from the higher frequency in accordance with the codes “00”, “01”, “11”, “10”, which are superimposed on the multi-valued FSK signal S1. Taking such system as an example, the operation of the embodiment can be explained as follows. That is, there are three threshold values for judging each of the codes, and the first threshold value is used for judging “00” and “01”, the second threshold value for judging “01” and “11”, and the third threshold value for judging “11” and “10”, respectively. The threshold value judging device 3 performs judgment of the codes of the demodulation base band signal S2 based on the three threshold values. The demodulation data signal S3, that is the result of data judgment, is sent to the demodulation signal synchronizing output device 6. The demodulation signal synchronizing output device 6 generates the synchronizing data clock S7 that corresponds to the already-known transmission speed. When the value of the demodulation data signal S3 is “00”, the two bits, “0” and “0”, are generated and outputted as the synchronizing digital data S8 by being synchronized with the synchronizing digital clock. Through performing data judgment under the digital data state in this manner, it is possible to judge the threshold value with high accuracy. Further, it is easy to deal with even the case where there is a change in the modulation degree, for example, since the threshold value can be set arbitrarily in the threshold value holding device 3 (register).

Further, the synchronizing point detector 4 detects the synchronizing point by detecting the changing point (specifically, the voltage changing point) of the demodulation base band signal S2. Though the various methods are considered for detecting the changing point of the demodulation base band signal S2, hereinafter, description will be given to a method that looks upon the detected point of the zero crossing point as the changing point, as an example of the simplest structure. The demodulation base band signal S2 is digital data. When it is expressed as a complement of “2”, the highest bit is a code bit. The changing point of the code bit, i.e. the point of transition from “0” to “1” or from “1” to “0” is the zero crossing point. The synchronizing point detector 4 detects the changing point by performing the over-sampling processing on the demodulation base band signal. The changing point can be detected with much higher accuracy by increasing the number of over-samplings. Description will be given here to the case where the over-samplings of ten-times are carried out as an example.

In the case where the over-samplings of ten-times are carried out, there are changing points of 0 to 9. Information indicating which of the changing points 0 to 9 is pertinent to the timing detected by the synchronizing point detector 4 is sent to the synchronizing point holding device 5 as the synchronizing point detected position information S5. The synchronizing point holding device 5 stores the information of the synchronizing point detected position information S5, and determines the most probable changing point as the synchronizing point to keep it as the synchronizing point. Specifically, as the values that can be taken as the information are from 0 to 9, counters corresponding to each value are provided and the count number of the counter corresponding to the transmitted information is made up one by one every time the information is transmitted. The changing point whose counter has the highest value is considered as the synchronizing point, and the synchronizing point position information S6n indicating the changing point that is considered as the synchronizing point is sent to the demodulation signal synchronizing output device 6.

The demodulation signal synchronizing output device 6 determines, as the data sampling point, the point that has past a half the time of the transmission speed from the synchronizing point based on the inputted synchronizing point position information S6. The transmission speed herein means the sampling cycle. The demodulation signal synchronizing output device 6 judges the value of the demodulation data signal S3 at the determined data sampling point, and outputs the judgment result as synchronizing digital data S8.

Further, the demodulation signal synchronizing output device 6 generates a clock that rises at the point of the synchronizing point position information S6 and falls at the data sampling point when the data sampling timing on the receiver side of the synchronizing digital data S8 falls, and outputs it as synchronizing digital clock S7.

As described above, in this embodiment, more accurate data judgment can be achieved through performing data sampling by determining the synchronizing point based on the changing point detection. Therefore, deterioration in the receipt characteristic can be suppressed even when the transmission speed is increased.

### Second Embodiment

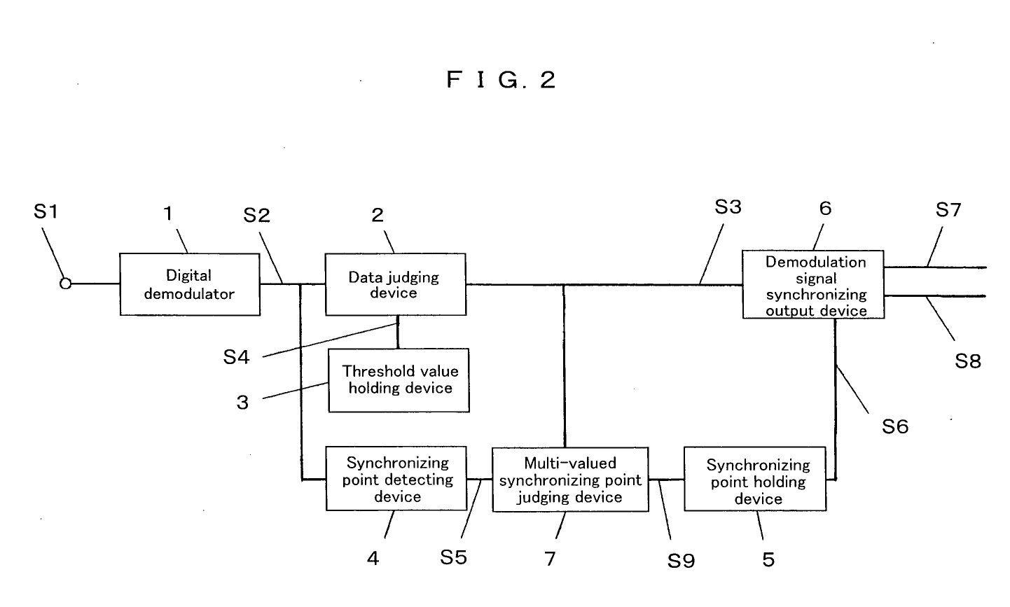

The radio demodulation circuit according to a second embodiment of the present invention will be described. FIG. 2 is a block diagram showing an example of the structure of the radio demodulation circuit according to the second embodiment, which shows the circuit structure of the main part for detecting the synchronizing point in the case of multi-valued FSK modulation.

The second embodiment comprises a multi-valued synchronizing point judging device 7 in addition to the structure of the first embodiment (FIG. 1). The multi-valued synchronizing point judging device 7 judges only the changing points of a specific four-valued FSK codes in the synchronizing point detected position information S5 and the demodulation data signal S3 as the synchronizing points. Hereinafter, the information regarding the detected positions of the multi-valued synchronizing points judged by the multi-valued synchronizing point judging device 7 is referred to as multi-valued synchronizing point detected position information S9. The multi-valued synchronizing point detected position information S9 is supplied to the synchronizing point holding device 5.

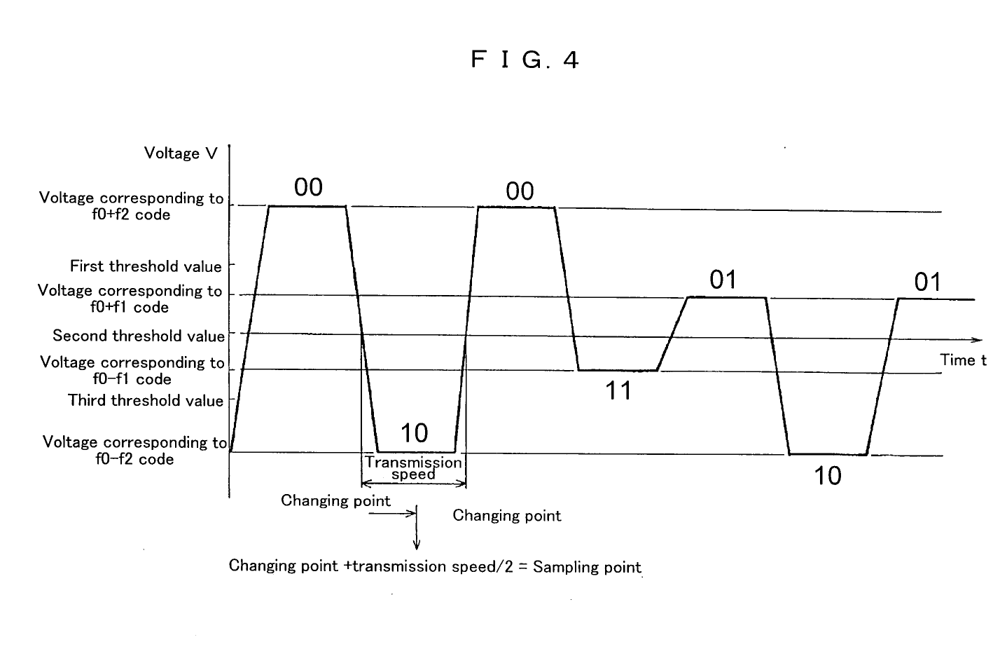

The operation of the radio demodulation circuit according to the second embodiment will be described hereinafter. When performing the four-valued FSK radio communication, the four-valued codes in the demodulation data signal S3 judged by the multi-valued synchronizing point judging device 7 change from “00” to “10”, “10” to “00” or “01” to “11”, “11” to “01”. That is, as shown in FIG. 4, the multi-valued synchronizing point judging device 7 judges, as the synchronizing points, only the sampling points (referred to as the code changing points hereinafter), which have voltage-transited to the code-corresponding voltage that corresponds to the modulation degree deviated by the same amount in the positive and negative direction from the voltage corresponding to the center frequency of the band, and sends the judgment result to the synchronizing point holder 5 as the multi-valued synchronizing point detected position information S9.

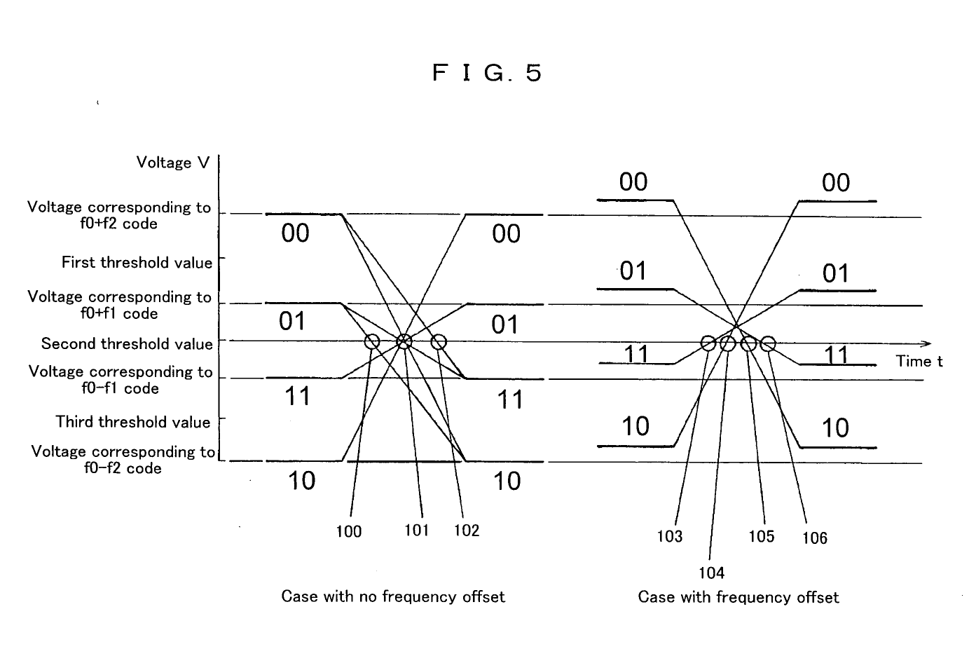

When the synchronizing points are detected through the code changing points in the synchronizing point detection in the case of multi-valued signals, the codes may transit under the state where the code changing points are deviated (inconsistent) from the synchronizing points. For example, referring to the changing point 100 of FIG. 5, the code is transited from “01” to “10”. At the code changing point 102, the code is transited from “00” to “11”. These code changing points 100 and 102 are deviated from the synchronizing point and not consistent with each other. Thus, in detecting the synchronizing point, the code changing point from “00” to “10” and the code changing point from “01” to “11”, or the code changing point from “10” to “00” and the code changing point from “11” to “01” may be considered as the synchronizing points, for example. Like this, by determining only the code changing points that are deviated by the same modulation degree as the synchronizing points, it is possible to detect the synchronizing points more accurately as shown in a detected point 101 of FIG. 5.

Further, in performing the four-valued FSK radio communication, the code changing point at which the four-valued code is transited from “00” to “10” or the code changing point at which the code is transited from “10” to “00” in the demodulation data signal S3, i.e. the code changing point at which the code is transited to the most deviated code in terms of the modulation degree, may selectively be judged as the synchronizing point by the multi-valued synchronizing point judging device 7. In this case, not both of the code changing points in both directions but either the code changing point at which the code is transited from “00” to “110” or the code changing point at which the code is transited from “10” to “00” may be judged as the synchronizing point. This provides a following advantage.

The case where there is a frequency offset will be supposed. Due to presence of an influence of the offset in this case, since the four code changing points 103, 104, 105, 106 may be judged as the synchronizing points as shown in FIG. 5 in the processing which judges the code changing points, that are deviated by the same modulation degree, as the synchronizing points, the synchronizing points may be dispersed. On the contrary, the processing, that judges only the code changing point with the most deviated modulation synchronizing point, carried out, only the two code changing points 104 and 105 are selectively judged as the synchronizing points. Therefore, it is possible to detect the synchronizing points accurately even when there is a frequency offset.

Further, only the code changing point at which the code is transited from “00” to “10” or the code changing point at which the code is transited from “10” to “00” may be judged as the synchronizing point. Herewith, the code changing point 104 or 105 shown in FIG. 5 can be selectively judged as the synchronizing point, so that the more accurate synchronizing point can be obtained.

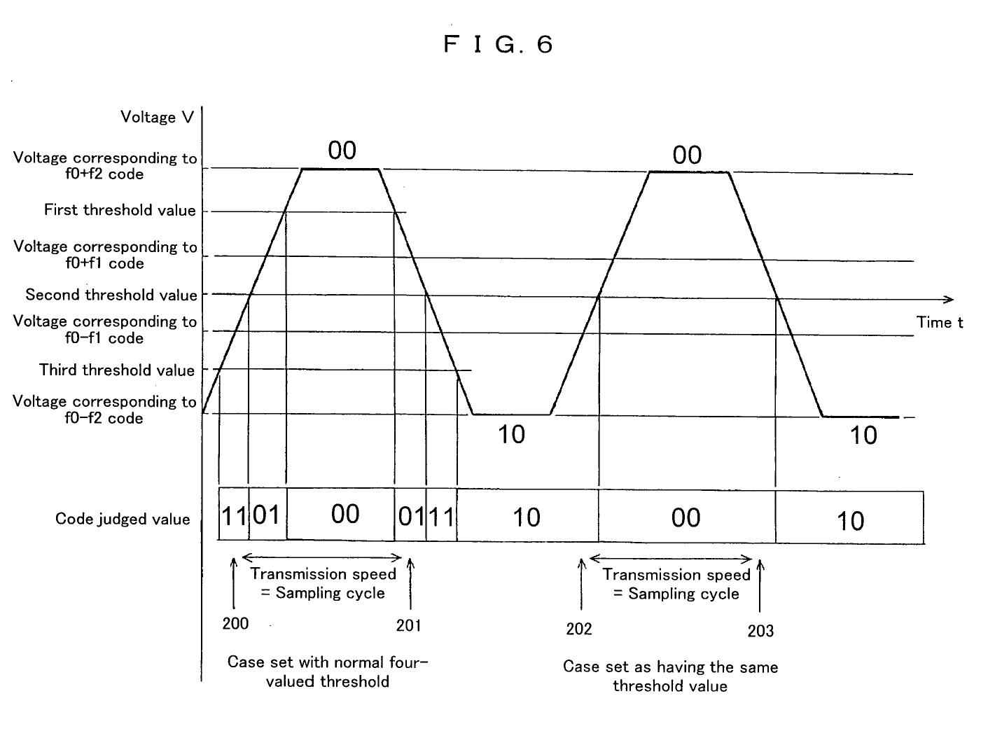

In general, in synchronizing between a transmitter and a receiver in radio communication, synchronization is achieved with a bit synchronizing code. In this case, the code to be transmitted repeats the continuous data of the code from which the transmission speed can be judged, i.e. “00” and “10”, if it is the four-valued FSK. Thus, when achieving synchronization with the bit synchronizing code, the value positioned in the middle of the values shown in the above-described information of the three threshold values is set as a threshold value that is differentiable into binary apparently. Herewith, as shown in FIG. 6, the multi-valued synchronizing point judging device 7 selectively extracts the synchronizing point at which the pseudo-change to binary is generated, so that the code judgment result becomes only “00” and “10”. Hereinafter, the reason why the code judgment result obtained by the multi-valued synchronizing point judging device 7 becomes only “00” and “10” will be described.

In the case where the code judging processing is performed in the radio demodulation circuit that achieves synchronization through the bit synchronizing code, when the code judgment processing is performed so that the judgment result obtained by the multi-valued synchronizing point judging device 7 includes at least “00”, “10”, if sampling points 200, 201 shown in FIG. 6 are mistakenly set as the initial synchronizing points, synchronization is achieved between the code “11” and the code “01” because the code changing point between “11” and “01” is judged subsequently as the synchronizing point. If synchronization is achieved once in this state, the changing point from the code “00” to the code “10” is not detected subsequently, so that the synchronizing point is not transited. As a result, the operation is to be continued at the wrong synchronizing timing.

On the contrary, in the case where the judging processing is performed so that the code judgment result obtained by the multi-valued synchronizing point judging device 7 includes only the code “00”, “10”, the correct synchronizing point can be determined even when the initial sampling is performed at the sampling points 202 and 203 shown in FIG. 6. Thus, synchronization between the transmitter side and the receiver side can be achieved promptly. Further, through setting the three threshold values again after synchronization is achieved between the transmitter side and the receiver side, correction of the synchronizing points can be performed during the communication. As the processing of determining the initial synchronizing point, for example, it is possible to determine the synchronizing point based on the counted number of the synchronizing points held in the synchronizing point holding device 5 as shown in FIG. 1.

### Third Embodiment

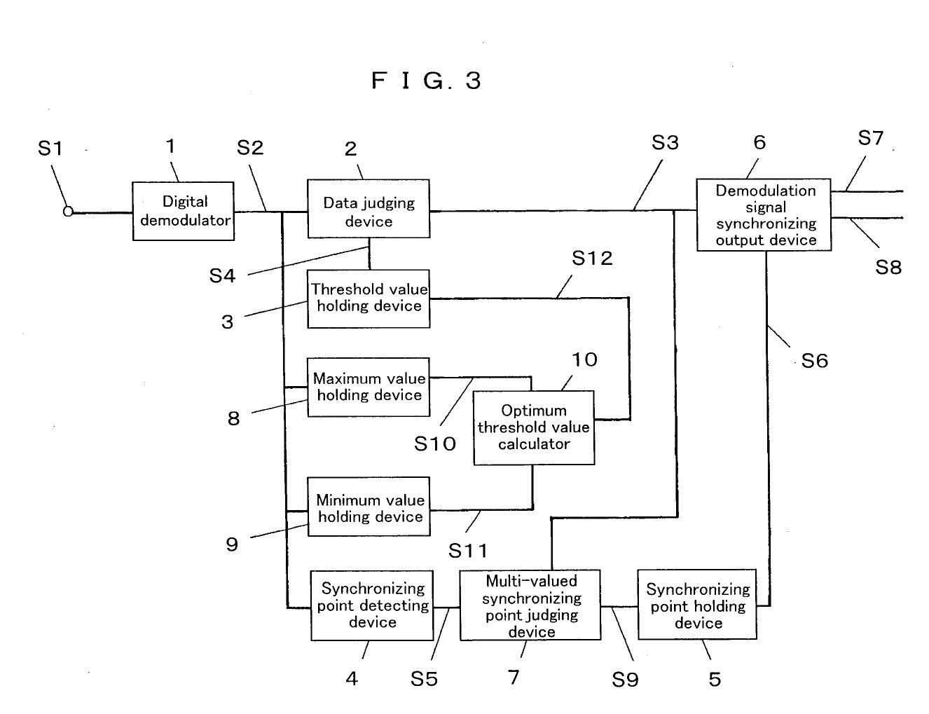

The radio demodulation circuit according to a third embodiment of the present invention will be described. FIG. 3 is a block diagram showing an example of the structure of the radio demodulation circuit according to the third embodiment, which shows the circuit structure of the main part for detecting the synchronizing point in the case of multi-valued FSK modulation.

The third embodiment comprises a maximum value holding device 8, a minimum value holding device 9, and an optimum threshold value calculator 10 in addition to the structure of the second embodiment (FIG. 2). The maximum value holding device 8 keeps the maximum value of the demodulation base band signal S2. Hereinafter, the information regarding the maximum value of the demodulation base band signal S2 outputted from the maximum value holding device 8 is referred to as maximum value information S10. The minimum value holding device 9 keeps the minimum value of the demodulation base band signal S2. Hereinafter, the information regarding the minimum value of the demodulation base band signal S2 outputted from the minimum value holding device 9 is referred to as minimum value information S1. The optimum threshold value calculator 10 calculates the optimum threshold value from the maximum value information 10 and the minimum value information S11. Hereinafter, the information regarding the optimum threshold value outputted from the optimum threshold value calculator 10 is referred to as optimum threshold value information S12. The optimum threshold value information S12 is supplied to the threshold value holding device 3.

Next, the detailed operation of the radio demodulation circuit according to the third embodiment will be described. Where the four-valued FSK communication is performed, the maximum value holding device 8 keeps the maximum value of the demodulation base band signal S2, and then supplies the output maximum value information S10 to the optimum threshold value calculator 10. The minimum threshold value holding device 9 keeps the minimum value of the demodulation base band signal S2, and then supplies the minimum value information S11 to the optimum threshold value calculator 10. The optimum threshold value calculator 10 determines the optimum threshold value from the output maximum value information S10 and the minimum value information S11. As shown in FIG. 4, the optimum threshold value can be obtained through dividing the maximum value and the minimum value of the demodulation base band signal S2 by 4. That is, a first threshold value is (the maximum value−the minimum value)×¾, a second threshold value is (the maximum value−the minimum value) × 2/4, and a third threshold value is (the maximum value−the minimum value)×¼.

Through sending the threshold value determined in this manner to the threshold value holding device 3, it becomes possible to determine the optimum threshold value in accordance with the radio wave condition and prevent the deterioration of the receipt characteristic, even if there is a variation in the frequency modulation degree on the transmitter side.

### Fourth Embodiment

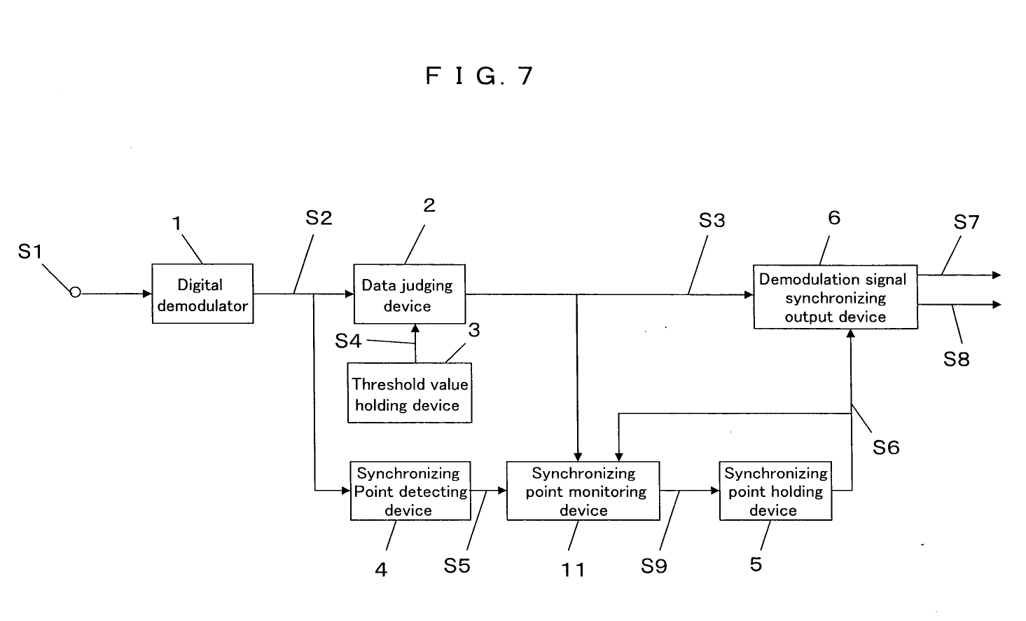

The radio demodulation circuit according to a fourth embodiment of the present invention will be described. FIG. 7 is a block diagram showing an example of the structure of the radio demodulation circuit according to the fourth embodiment, which shows the circuit structure of the main part for detecting the synchronizing point at the time of multi-valued FSK modulation. The fourth embodiment comprises a synchronizing point monitoring device 11 in addition to the structure of the first embodiment (FIG. 1). The synchronizing point monitoring device 11 considers, as the accurate synchronizing points, the synchronizing points detected along the synchronizing cycle on some level (for example, within the time of ±0.2 sampling), which is estimated from the synchronizing point group that is determined in advance among the synchronizing point group (the code changing point group) detected by the synchronizing point detecting device 4. Meanwhile, the synchronizing point monitoring device 11 does not consider the synchronizing points that are deviated from the synchronizing cycle on some level (within the same range as the aforementioned range) as the accurate synchronizing points. The synchronizing point monitoring device 11 sends the synchronizing point monitoring information S9, that indicates the result obtained by carrying out such synchronizing point monitoring, to the synchronizing point holding device 5.

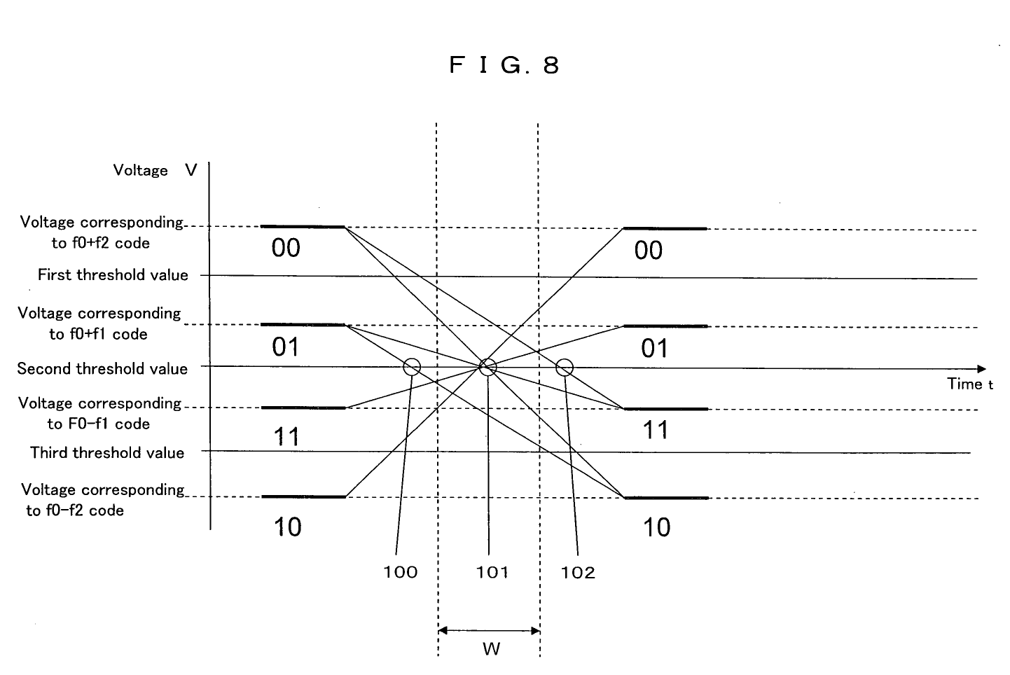

Hereinafter, the detailed operation of the radio demodulation circuit according to the fourth embodiment will be described. Where the four-valued FSK radio communication is performed, the synchronizing point monitoring device 11 generates the information S9 based on the synchronizing point position information S6, indicating that the synchronizing points (code changing points) deviated from the synchronizing cycle on some level are not considered as the accurate synchronizing points and other synchronizing points (the synchronizing points that are along the synchronizing cycle on some level) are considered as the accurate synchronizing points, and then sends the information S9 to the synchronizing point holding device 5. Hereinafter, description will be given to the case, as an example, where synchronization is achieved first through a signal whose code transits from “00” to “10” or from “10” to “00” in synchronizing as shown in FIG. 8, and an operation is performed setting the code changing point 101 as the synchronizing point.

In this case, the synchronizing point monitoring device 11 sets in advance the synchronizing point monitoring range W that has an arbitrary width before and after from the center of the accurate synchronizing point (the code changing point 101 in this case) on the time axis. The synchronizing point monitoring device 11 selectively extracts the synchronizing point (code changing point), that is detected within the synchronizing point monitoring range W, as the accurate synchronizing point, but does not extracts the synchronizing point detected in the time band out of the synchronizing point monitoring range W as the accurate synchronizing point. Herewith, for example, as shown in FIG. 8, in the synchronizing point (code changing point) 100 that is detected by the synchronizing point detecting device 4 as having the code transited from “01” to “10” or the synchronizing point 102 that is detected by the synchronizing point detecting device 4 as having the code transited from “00” to “11”, the detected timings thereof are not included within the synchronizing point monitoring range W. Therefore, the synchronizing point monitoring device 11 does not consider the synchronizing points 100 and 102 as the accurate synchronizing points.

Like this, the synchronizing point monitoring device 11 generates the synchronizing point monitoring information S9 that does not consider the synchronizing points 100, 102 as the accurate synchronizing points, but considers only the synchronizing point 101 as the accurate synchronizing point, and provide it to the synchronizing point holding device 5. Therefore, only the synchronizing point 101 detected within the synchronizing point monitoring range W among the synchronizing point group that is detected by the synchronizing point detecting device 4 is selectively held in the synchronizing point holding device 5 as the accurate synchronizing point. Further, a limit is put on the number of times for not considering, as the accurate synchronizing points, the synchronizing points that are detected by being deviated to a certain extent or more by the synchronizing point monitoring device 11. The limited number may be a fixed value or a variable. When the communication partner changes, the synchronizing points are shifted and an accurate communication cannot be achieved, while the communication is performed under the state where it is less than the limited number for not considering the synchronizing pint as the accurate synchronizing point. Meanwhile, when a synchronizing point is detected exceeding the limited number at the point to be not considered as the synchronizing point, that point is considered as the synchronizing point. That is, that point is corrected (set) as the synchronizing point with the changed communication partner.

Through monitoring such synchronizing points by the synchronizing point monitoring device 11, it becomes possible to detect the stable synchronizing points even in the four-valued FSK radio communication. Therefore, the four-valued radio communication can be continued stably even if an unwanted noise is mixed temporarily.

### Fifth Embodiment

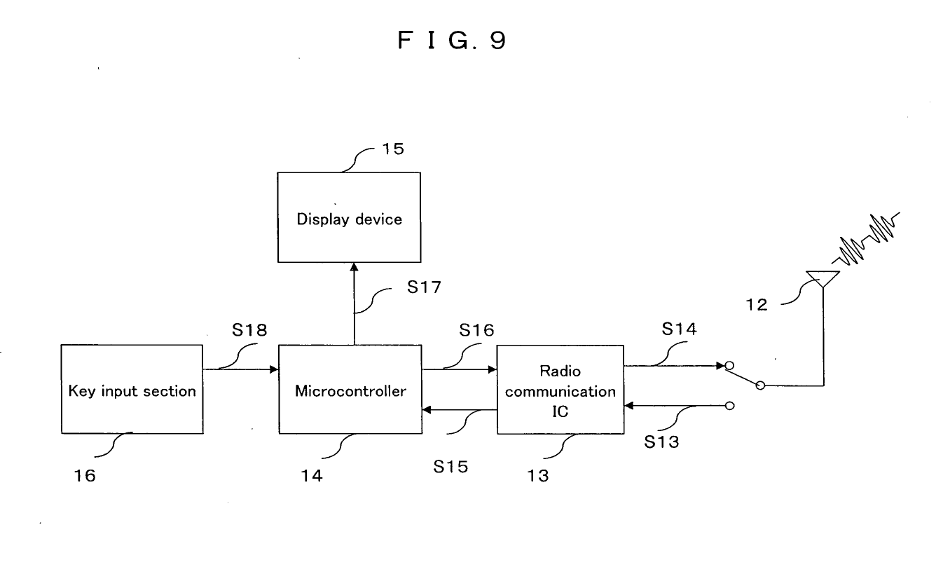

A fifth embodiment of the present invention shown in FIG. 5 is a remote controller to which the radio demodulation circuit of the present invention is mounted. In FIG. 9, reference numeral 12 is an antenna through which radio waves are transmitted and received. Reference numeral 13 is a radio communication IC to which the radio demodulation circuit according to one of the first to fourth embodiments is mounted. Reference numeral 14 is a microcontroller, 15 is a display device, and 16 is a key input section.

Hereinafter, the detailed operation of the remote controller according to the fifth embodiment will be described. In a typical radio communication, the action is started through synchronizing with the communication partner. The radio waves from the communication partner are received with the antenna 12. The receiving signal is inputted to the radio communication IC 13 as a radio receiving signal S13. The radio communication IC 13 comprises the radio demodulation circuit according to one of the first to fourth embodiments, so that the stable multi-valued FSK communication can be achieved by establishing the synchronization with the communication partner. The radio communication IC 13 sends radio reception demodulation data S15 to the microcontroller 14. The microcontroller 14 generates a signal for transmitting to the communication partner that the synchronization is established from the radio reception demodulation data, as radio transmission demodulation data S16, and sends it to the radio communication IC 13. The radio communication IC 13 performs multi-valued modulation on the data S16 so as to generate the radio transmission signal S14, and transmits it as the radio wave through the antenna S12.

For example, in the case where an air conditioner is the communication partner of the remote controller, when it is in an OFF state, first, the operator performs key-input action through the key input section 16 for giving an instruction to turn ON the air conditioner. This instruction is sent from the key input section 16 to the microcontroller 14 as a key input signal S18. The microcontroller 14 generates command data for turning ON the air conditioner, and converts the command data to the radio modulation data S16. The microcontroller 14 sends the radio modulation data S16 to the radio communication IC 13, and the radio communication IC 13 generates the radio modulation signal S14 on which the radio modulation data S16 is superimposed, and outputs it as the radio wave through the antenna 12.

When the air conditioner as the radio communication partner returns the radio wave on which the information indicating that itself has turned ON, and the ones on the current room temperature, the set temperature and the like are superimposed, the antenna 12 receives the radio wave, converts it into the radio receiving signal S13 and sends it to the radio communication IC 13. The radio communication IC 13 sends the radio demodulation data S15 to the microcontroller 14. The microcontroller 14 notices that the air conditioner has turned ON and about the current room temperature, the set temperature and the like from the transmitted information, and generates display device control signal S17 indicating the judgment results thereof to send it to the display device 15. The display device 15 displays that the air conditioner is ON, as well as the current room temperature, the set temperature etc., based on the display device control signal S17.

Through performing the stable multi-valued FSK communication with the communication partner in this manner, high-speed communication can be achieved even with the same data amount. Thus, it is possible to suppress the amount of electric current consumption. With this, the amount of the battery consumption in the remote controller can be suppressed, which enables reduction in the size of the battery and reduction in the size of the remote controller itself as a result. Further, high-speed bidirectional communication can be achieved, thereby it enables one-to-many communication or the like, which has not been achieved by a conventional remote controller using infrared rays. This further improves the additional values thereof.

The present invention has been described in detail referring to the most preferred embodiments. However, various combinations and modifications of the components are possible without departing from the spirit and the broad scope of the appended claims.

What is claimed is:

1. A radio demodulation circuit, comprising:
a digital demodulator for demodulating a multi-valued FSK signal;
a data judging device for judging a threshold value of a demodulated output of said digital demodulator; and
a threshold value holding device for keeping said threshold value obtained by said data judging device.

2. The radio demodulation circuit according to claim 1, further comprising:
a synchronizing point detecting device that detects changing points in said demodulated output, and then detects synchronizing points of said multi-valued FSK signal based on said changing points that have been detected; and
a demodulation signal synchronizing output device that outputs a threshold value judgment result through said data judging device at said synchronizing points, and a synchronizing clock that synchronizes with transmission speed of said demodulated output.

3. The radio demodulation circuit according to claim 2, further comprising a synchronizing point holding device for keeping said synchronizing points.

4. The radio demodulation circuit according to claim 2, further comprising a multi-valued synchronizing point judging device, wherein:
said multi-valued FSK signal has a plurality of frequency components whose modulation degrees are set in accordance with each code that is superimposed on said signal;
said demodulated output has a plurality of voltage components that correspond to said plurality of frequency components; and
said multi-valued synchronizing point judging device selectively judges said synchronizing points, as synchronizing points, at which a voltage transition is generated between said voltage components that correspond to said frequency components whose said modulation degrees are deviated equally to one another from a center frequency of said multi-valued FSK signal in said threshold value judgment result.

5. The radio demodulation circuit according to claim 2, further comprising a multi-valued synchronizing point judging device, wherein:
said multi-valued FSK signal has a plurality of frequency components whose modulation degrees are set in accordance with each code that is superimposed on said signal;
said demodulated output has a plurality of voltage components that correspond to said plurality of frequency components; and
said multi-valued synchronizing point judging device extracts said synchronizing point from a synchronizing point group that is detected by said synchronizing point detecting device in said threshold value judgment result, at which a voltage transition is generated between said voltage components that correspond to said frequency components whose said modulation degrees are largest to a center frequency of said multi-valued FSK signal, and judges said extracted synchronizing point as a synchronizing point.

6. The radio demodulation circuit according to claim 5, wherein:
said threshold value holding device sets threshold values that is apparently differentiable into binary, as said threshold values in multi-valued modulation; and
said multi-valued synchronizing point judging device extracts said synchronizing point at which a change to binary is generated apparently in said threshold value judgment result, and judges said extracted synchronizing points as synchronizing points.

7. The radio demodulation circuit according to claim 1, comprising:
a maximum value holding device for keeping a maximum value of said demodulated output;
a minimum value holding device for keeping a minimum value of said demodulated output; and
an optimum threshold value calculator for calculating an optimum value of said threshold values from an output of said maximum value holding device and an output of said minimum value holding device, wherein
said threshold value holding device keeps said threshold value calculated by said optimum threshold value calculator.

8. The radio demodulation circuit according to claim 3, further comprising a synchronizing point monitoring device wherein said synchronizing point monitoring device determines a synchronizing point based on a counted number of said synchronizing points held in said synchronizing point holding device; after determining said synchronizing point, extracts synchronizing points that said synchronizing point detector detects within an arbitrary range on a time axis with a central focus on said determined synchronizing point; and judges said extracted synchronizing points as synchronizing points.

9. A remote controller, comprising:
a radio communication LSI to which the radio demodulation circuit according to claim 1 is mounted for performing radio transmission and reception;
an antenna for transmitting and receiving a radio signal of said radio communication LSI;
a microcontroller for performing a control of said radio communication LSI;
a key input device for performing input to said microcontroller; and
a display device for performing an arbitrary display through a control from said microcontroller.
